(19) United States
(12) Patent Application Publication
(10) Pub. No.: US 2020/0411900 A1
(43) Pub. Date: Dec. 31, 2020

(54) INSULATION LAYER, BATTERY CELL SHEET, AND BATTERY

(71) Applicant: HITACHI, LTD., Tokyo (JP)

(72) Inventors: Atsushi UNEMOTO, Tokyo (JP); Motoyuki HIROOKA, Tokyo (JP); Jun KAWAJI, Tokyo (JP); Takefumi OKUMURA, Tokyo (JP)

(73) Assignee: HITACHI, LTD., Tokyo (JP)

(21) Appl. No.: 16/979,214

(22) PCT Filed: Feb. 14, 2019
(86) PCT No.: PCT/JP2019/005261

§ 371 Date: Sep. 9, 2020

(30) Foreign Application Priority Data
Apr. 9, 2018 (JP) 2018-074366

(51) Int. Cl. H01M 10/058; H01M 10/054; H01M 10/0566; H01M 10/42; H01M 2/16; H01M 4/13; H01M 4/62

(52) U.S. Cl. CPC H01M 10/058; H01M 10/054; H01M 10/0566; H01M 2300/0091; H01M 2/16; H01M 4/13; H01M 4/621; H01M 10/4235

(57) ABSTRACT

An insulation layer that improves the safety of a battery, a battery cell sheet and a battery, include an insulation layer having a non-aqueous electrolyte, insulation layer particles, and an insulation layer binder, wherein the non-aqueous electrolyte has a non-aqueous solvent with a volatilization temperature of less than 246.degree.C., and when the insulation layer has been heated higher than a reference temperature, the temperature at which the weight of the insulation layer reduces by 10% compared to the weight of the insulation layer at the reference temperature is at least 3.degree.C. higher than the temperature at which the weight of the non-aqueous solvent reduces by 10% compared to the weight of the non-aqueous solvent at the reference temperature. Also provided are a battery cell sheet and a battery that are provided with said insulation layer.

### TECHNICAL FIELD

The present invention relates to an insulation layer, a battery cell sheet, and a battery.

### BACKGROUND ART

PTL 1 discloses the following as a technique of coating a mixture on a porous substrate. An organic/inorganic composite porous film contains (a) inorganic particles, and (b) a binder polymer coating layer formed partially or totally on surfaces of the inorganic particles, wherein the inorganic particles are interconnected among themselves and are fixed by the binder polymer, and interstitial volumes among the inorganic particles form a micropore structure. An electrochemical device including the organic/inorganic composite porous film can simultaneously have improved safety and performance.

### CITATION LIST

### Patent Literature

PTL 1: JP 2016-6781 A

### SUMMARY OF INVENTION

### Technical Problem

When a non-aqueous electrolyte solution contains a low-volatile solvent such as an ionic liquid, the ionic conductivity of an insulation layer may not be sufficient. Meanwhile, by incorporating a highly volatile organic electrolyte solution into the non-aqueous electrolyte solution, the ionic conductivity of the insulation layer is improved. However, when the insulation layer contains the highly volatile organic electrolyte solution, the non-aqueous electrolyte solution in the insulation layer is volatilized, which may cause reduced safety of a battery.

PTL 1 describes improvements in rate characteristics and ionic conductivity provided by controlling inorganic particles, but no suggestion for the above is found. It is an object of the present invention to improve the safety of a battery.

### Solution to Problem

The features of the present invention for solving the above problems are as follows, for example.

An insulation layer including: a non-aqueous electrolyte solution; insulation layer particles; and an insulation layer binder, wherein the non-aqueous electrolyte solution contains a non-aqueous solvent having a volatilization temperature of lower than 246° C., and when the insulation layer is heated from a reference temperature, a temperature at which a weight of the insulation layer is reduced by 10% compared to the weight of the insulation layer at the reference temperature is higher by at least 3° C. than a temperature at which a weight of the non-aqueous solvent is reduced by 10% compared to the weight of the non-aqueous solvent at the reference temperature.

### Advantageous Effects of Invention

The present invention can improve the safety of a battery. The problems, constitutions, and effects other than those described above are apparent from the descriptions of the following embodiments.

### BRIEF DESCRIPTION OF DRAWINGS

FIG. 1 is a sectional view of a secondary battery.

FIG. 2 show Results of Examples and Comparative Examples.

### DESCRIPTION OF EMBODIMENTS

Hereinafter, embodiments of the present invention will be described below with reference to the drawings and the like. The following description shows specific examples of contents of the present invention, and the present invention is not limited thereto. Various changes and modifications can be made by those skilled in the art within the scope of the technical idea disclosed in the description. In all the drawings for explaining the present invention, those having the same functions are denoted by the same numerals and repeated descriptions thereof may be omitted.

The expression “to” described in the description is used with a meaning of including numerical values described therebefore and thereafter as a lower limit value and an upper limit value. In the numerical ranges described stepwise in the description, an upper limit value or a lower limit value described in one numerical range may be replaced with another upper limit value or lower limit value described stepwise. An upper limit value or a lower limit value of the numerical ranges described in the description may be replaced with a value shown in Examples.

In the description, a lithium ion secondary battery will be described as an example of a secondary battery. The lithium ion secondary battery is an electrochemical device that can store or utilize electrical energy by occluding lithium ions from an electrode in an electrolyte and releasing lithium ions to the electrode. This is also referred to as other names of a lithium ion battery, a non-aqueous electrolyte secondary battery, and a non-aqueous electrolyte solution secondary battery, any of which is an object of the present invention. The technical idea of the present invention is also applicable to a sodium ion secondary battery, a magnesium ion secondary battery, a calcium ion secondary battery, a zinc secondary battery, and an aluminum ion secondary battery and the like.

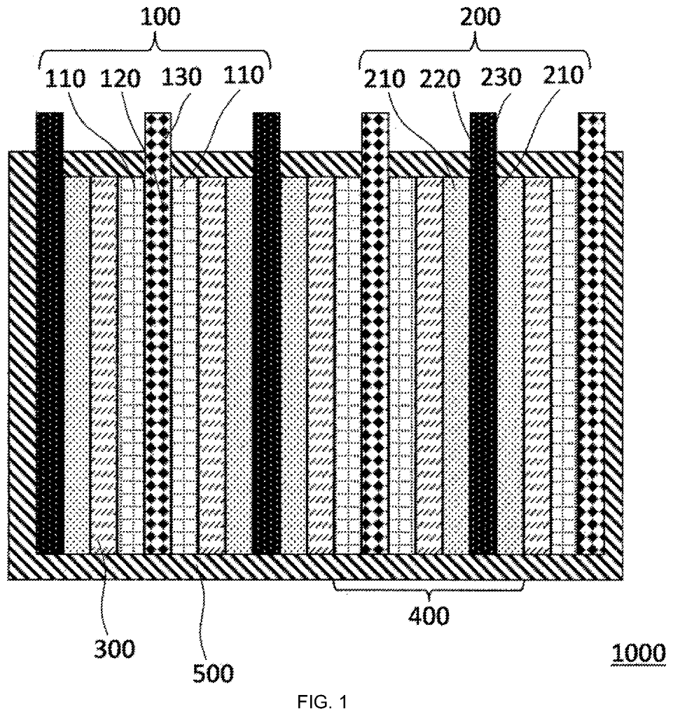

FIG. 1 is a cross-sectional view of a secondary battery according to one embodiment of the present invention. FIG. 1 is a stacked type secondary battery, in which a secondary battery 1000 includes a positive electrode 100, a negative electrode 200, an outer casing 500, and an insulation layer 300. The outer casing 500 houses the insulation layer 300, the positive electrode 100, and the negative electrode 200. A material of the outer casing 500 may be selected from materials having corrosion resistance to non-aqueous electrolyte solutions such as aluminum, stainless steel, and nickel-plated steel. The present invention is also applicable to a winding-type secondary battery.

Electrode bodies 400 each including the positive electrode 100, the insulation layer 300, and the negative electrode 200 are stacked in the secondary battery 1000. The positive electrode 100 or the negative electrode 200 may be referred to as an electrode. The positive electrode 100, the negative electrode 200, or the insulation layer 300 may be referred to as a secondary battery sheet. A structure in which the insulation layer 300 and the positive electrode 100 or the negative electrode 200 are integrated may be referred to as a battery cell sheet.

The positive electrode 100 includes a positive electrode current collector 120 and positive electrode mixture layers 110. The positive electrode mixture layers 110 are formed on both surfaces of the positive electrode current collector 120. The negative electrode 200 includes a negative electrode current collector 220 and negative electrode mixture layers 210. The negative electrode mixture layers 210 are formed on both surfaces of the negative electrode current collector 220. The positive electrode mixture layer 110 or the negative electrode mixture layer 210 may be referred to as an electrode mixture layer, and the positive electrode current collector 120 or the negative electrode current collector 220 may be referred to as an electrode current collector.

The positive electrode current collector 120 includes a positive electrode tab part 130. The negative electrode current collector 220 includes a negative electrode tab part 230. The positive electrode tab part 130 or the negative electrode tab part 230 may be referred to as an electrode tab part. No electrode mixture layer is formed on the electrode tab part. However, the electrode mixture layer may be formed on the electrode tab part within a range that does not adversely affect the performance of the secondary battery 1000. The positive electrode tab part 130 and the negative electrode tab part 230 protrude outward from the outer casing 500, and a plurality of protruding positive electrode tab parts 130 and a plurality of negative electrode tab parts 230 are bonded by, for example, ultrasonic bonding, so that a parallel connection is formed in the secondary battery 1000. The present invention is also applicable to a bipolar type secondary battery in which an electrical series connection is configured in the secondary battery 1000.

The positive electrode mixture layer 110 contains a positive electrode active material, a positive electrode conductive agent, and a positive electrode binder. The negative electrode mixture layer 210 contains a negative electrode active material, a negative electrode conductive agent, and a negative electrode binder. The positive electrode active material or the negative electrode active material may be referred to as an electrode active material. The positive electrode conductive agent or the negative electrode conductive agent may be referred to as an electrode conductive agent. The positive electrode binder or the negative electrode binder may be referred to as an electrode binder.

### Electrode Conductive Agent

The electrode conductive agent improves the conductivity of the electrode mixture layer. Examples of the electrode conductive agent include, but are not limited to, ketjen black, acetylene black, and graphite. These materials may be used alone or in combination of two or more.

### Electrode Binder

The electrode binder binds the electrode active material and the electrode conductive agent and the like in the electrode. Examples of the electrode binder include, but are not limited to, styrene-butadiene rubber, carboxymethyl cellulose, polyvinylidene fluoride (PVDF), and a copolymer of vinylidene fluoride (VDF) and hexafluoropropylene (HFP) (P(VdF-HFP)). These materials may be used alone or in combination of two or more.

### Positive Electrode Active Material

In the positive electrode active material exhibiting a nobler potential, lithium ions are desorbed in a charging process, and lithium ions desorbed from the negative electrode active material are inserted in a discharging process. The positive electrode active material is desirably a lithium composite oxide containing a transition metal. Examples of the positive electrode active material include LiMO₂, Li[LiM]O₂ having a Li excessive composition, LiM₂O₄, LiMPPO₄, LiMVOₓ, LiMBO₃, Li₂MSiO₄ (where M contains at least one of Co, Ni, Mn, Fe, Cr, Zn, Ta, Al, Mg, Cu, Cd, Mo, Nb, W, and Ru and the like). A part of oxygen in these materials may be replaced with another element such as fluorine. Another examples thereof include, but are not limited to, sulfur, chalcogenides such as TiS₂, MoS₂, Mo₆S₈, and TiSe₂, vanadium-based oxides such as V₂O₅, halides such as FeF₃, and quinone-based organic crystals such as Fe(MoO₄)₃, Fe₂(SO₄)₃, and Li₃Fe₂(PO₄)₃ forming polyanions. The element ratio may deviate from the above stoichiometric composition.

### Positive Electrode Current Collector 120

Examples of the positive electrode current collector 120 include, but are not limited to, an aluminum foil having a thickness of 1 to 100 μm, an aluminum perforated foil having a thickness of 10 to 100 μm and a hole with a hole diameter of 0.1 to 10 mm, an expanded metal, a foamed metal plate, stainless steel, and titanium.

### Negative Electrode Active Material

In the negative electrode active material exhibiting a low potential, lithium ions are desorbed in a discharging process, and lithium ions desorbed from the positive electrode active material in the positive electrode mixture layer 110 are inserted in a charging process. Examples of the negative electrode active material include, but are not limited to, carbon-based materials (graphite, a graphitizable carbon material, an amorphous carbon material, an organic crystal, and activated carbon and the like), conductive polymer materials (polyacene, polyparaphenylene, polyaniline, and polyacetylene and the like), lithium composite oxides (lithium titanate: Li₄Ti₅O₁₂ and Li₂TiO₄ and the like), metal lithium, metals (containing at least one of aluminum, silicon, and tin and the like) to be alloyed with lithium, and oxides thereof.

### Negative Electrode Current Collector 220

Examples of the negative electrode current collector 220 include, but are not limited to, a copper foil having a thickness of 1 to 100 μm, a copper piercing foil having a thickness of 1 to 100 μm and a hole with a hole diameter of 0.1 to 10 mm, an expanded metal, a foamed metal plate, stainless steel, titanium, and nickel.

### Electrode

An electrode mixture layer is prepared by applying an electrode slurry prepared by mixing an electrode active material, an electrode conductive agent, an electrode binder, and an organic solvent to an electrode current collector by a coating method such as a doctor blade method, a dipping method, or a spray method. The electrode mixture layer is then dried to remove the organic solvent, and the electrode mixture layer is pressure-molded by a roll press to produce the electrode.

When the non-aqueous electrolyte solution is contained in the electrode mixture layer, the content of the non-aqueous electrolyte solution in the electrode mixture layer is desirably 20 to 40% by volume. When the content of the non-aqueous electrolyte solution is small, an ion conduction path inside the electrode mixture layer may not be sufficiently formed, which causes deteriorated rate characteristics. When the content of the non-aqueous electrolyte solution is large, the non-aqueous electrolyte solution may leak out from the electrode mixture layer. In addition, the electrode active material may be insufficient, which causes a decreased energy density.

When the electrode has a semi-solid electrolyte, the non-aqueous electrolyte solution may be injected into the secondary battery 1000 from the open side or injection hole of the outer casing 500, to fill fine pores of the electrode mixture layer with the non-aqueous electrolyte solution. As a result, particles made of the electrode active material and the electrode conductive agent and the like in the electrode mixture layer function as carrier particles and retain the non-aqueous electrolyte solution without requiring the carrier particles contained in the semi-solid electrolyte. As another method for filling the fine pores of the electrode mixture layer with the non-aqueous electrolyte solution, a slurry obtained by mixing the non-aqueous electrolyte solution, the electrode active material, the electrode conductive agent, and the electrode binder is prepared, and the prepared slurry is coated together onto the electrode current collector.

The thickness of the electrode mixture layer is desirably equal to or greater than the average particle diameter of the electrode active material. When the thickness of the electrode mixture layer is small, electron conductivity between adjacent electrode active materials may be deteriorated. When coarse particles having an average particle diameter equal to or greater than the thickness of the electrode mixture layer are contained in an electrode active material powder, the coarse particles are desirably removed in advance by sieve separation or wind stream separation or the like to cause particles having an average particle diameter equal to or less than the thickness of the electrode mixture layer to be contained in the electrode active material powder.

### Insulation Layer 300

The insulation layer 300 serves as a medium that transmits ions between the positive electrode 100 and the negative electrode 200. The insulation layer 300 also acts as an electron insulator to prevent a short circuit between the positive electrode 100 and the negative electrode 200. The insulation layer 300 includes a coated separator or a semi-solid electrolyte layer. As the insulation layer 300, the coated separator or the semi-solid electrolyte layer may be used together. A resin separator may be added to the coated separator or the semi-solid electrolyte layer.

It is desirable that the thickness of the insulation layer 300 is 10 to 200 μm, preferably 15 to 150 μm, and more preferably 20 to 100 μm. If the insulation layer 300 has a large thickness, the internal resistance of the secondary battery 1000 may be increased. If the insulation layer 300 has a small thickness, an internal short circuit may occur.

### Resin Separator

A porous sheet can be used as the resin separator. Examples of the porous sheet include, but are not limited to, celluloses and the modifications (carboxy methyl cellulose (CMC), hydroxypropylcellulose (HPC) and the like); polyolefins (polypropylene (PP), a propylene copolymer and the like); polyesters (polyethylene terephthalate (PET), polyethylene naphthalate (PEN), polybutylene terephthalate (PBT) and the like); resins such as polyacrylonitrile (PAN), polyaramid, polyamide imide and polyimide; and glass. These materials may be used alone or in combination of two or more. By causing the resin separator to have a larger area than that of the positive electrode 100 or the negative electrode 200, a short circuit between the positive electrode 100 and the negative electrode 200 can be prevented.

### Coated Separator

A coated separator is formed by coating a separator forming mixture containing separator particles (insulation layer particles), a separator binder (insulation layer binder), and a solvent on a substrate such as an electrode mixture layer. The separator forming mixture may be coated on the above porous sheet.

Examples of the separator particles include, but are not limited to, the following carrier particles. These materials may be used alone or in combination of two or more. The average particle diameter of the separator particles is desirably 1/100 to ½ of the thickness of the separator. Examples of the separator binder include, but are not limited to, the following semi-solid electrolyte binders. These materials may be used alone or in combination of two or more. Examples of the solvent include, but are not limited to, N-methylpyrrolidone (NMP) and water.

When the resin separator or the coated separator is used as the insulation layer 300, the non-aqueous electrolyte solution is injected into the secondary battery 1000 from the open side or injection hole of the outer casing 500, to fill the separator with the non-aqueous electrolyte solution.

### Semi-Solid Electrolyte Layer

The semi-solid electrolyte layer contains a semi-solid electrolyte binder and a semi-solid electrolyte. The semi-solid electrolyte contains carrier particles and a non-aqueous electrolyte solution. The semi-solid electrolyte has fine pores formed by the aggregate of the carrier particles, and the non-aqueous electrolyte solution is retained in the fine pores. The non-aqueous electrolyte solution is retained in the semi-solid electrolyte, whereby the semi-solid electrolyte allows lithium ions to pass therethrough. When the semi-solid electrolyte layer is used as the insulation layer 300, and the electrode mixture layer is filled with the non-aqueous electrolyte solution, it is not necessary to inject the non-aqueous electrolyte solution into the secondary battery 1000. When the insulation layer 300 includes a separator, the non-aqueous electrolyte solution may be injected into the secondary battery 1000 from the open side or injection hole of the outer casing 500.

Examples of a method for preparing the semi-solid electrolyte layer include a method for compression-molding the semi-solid electrolyte powder into a pellet shape with a molding dice or the like, and a method for adding and mixing the semi-solid electrolyte binder with the semi-solid electrolyte powder so as to form a sheet. By adding and mixing the semi-solid electrolyte binder powder with the semi-solid electrolyte, the highly flexible sheet-like semi-solid electrolyte layer can be prepared. The semi-solid electrolyte layer may also be prepared by adding and mixing a binder solution in which the semi-solid electrolyte binder is dissolved in a dispersion solvent with the semi-solid electrolyte, coating the mixture on a substrate such as an electrode, and distilling off the dispersion solvent by drying.

### Carrier Particles

From the viewpoint of electrochemical stability, it is preferable that the carrier particles (insulation layer particles) are insulating particles and are insoluble in the non-aqueous electrolyte solution. As the carrier particles, oxide inorganic particles such as SiO₂ particles, Al₂O₃ particles, ceria (CeO₂) particles, and ZrO₂ particles can be preferably used. A solid electrolyte may be used as the carrier particles. Examples of the solid electrolyte include particles made of an inorganic solid electrolyte such as an oxide solid electrolyte (such as Li—La—Zr—O) and a sulfide solid electrolyte (such as Li₁₀Ge₂PS₁₂).

Since the amount of the non-aqueous electrolyte solution retained is considered to be proportional to the specific surface area of the carrier particles, the average particle diameter of primary particles of the carrier particles is preferably 1 nm to 10 μm. When the average particle diameter of the primary particles of the carrier particles is large, the carrier particles cannot properly retain a sufficient amount of the non-aqueous electrolyte solution, which may cause difficult formation of the semi-solid electrolyte. When the average particle diameter of the primary particles of the carrier particles is small, a surface force between the carrier particles increases, so that the carrier particles are likely to aggregate, which may make it difficult to form the semi-solid electrolyte. The average particle diameter of the primary particles of the carrier particles is more preferably 1 to 50 nm, and still more preferably 1 to 10 nm. The average particle diameter of the primary particles of the carrier particles can be measured using TEM.

### Non-Aqueous Electrolyte Solution

The non-aqueous electrolyte solution contains a non-aqueous solvent having a volatilization temperature of lower than 246° C. When the insulation layer is heated from a reference temperature, a temperature at which a weight of the insulation layer 300 is reduced by 10% compared to the weight of the insulation layer 300 at the reference temperature is higher by at least 3° C., and desirably at least 5° C. than a temperature at which a weight of the non-aqueous solvent is reduced by 10% compared to the weight of the non-aqueous solvent at the reference temperature. When a base of the insulation layer 300 is an electrode mixture layer containing a non-aqueous solvent, the weight of the insulation layer 300 at the reference temperature may be the weight of the non-aqueous solvent contained in the insulation layer 300, the electrode mixture layer, and the electrode current collector. As a result, an increase in a volatilization temperature due to the interaction between the surface of the particles in the insulation layer 300 and the non-aqueous solvent is larger than a decrease in the volatilization temperature due to an increase in a specific surface area inside the insulation layer 300, whereby the volatilization temperature can be increased, which makes it possible to provide improved battery safety.

The non-aqueous solvent contains a mixture (complex) of an organic solvent or an ether-based solvent which exhibits similar properties to those of an ionic liquid and a solvated electrolyte salt. The organic solvent or the ether-based solvent may be referred to as a main solvent. The non-aqueous electrolyte solution may contain an ionic liquid. The ionic liquid is a compound that dissociates into cations and anions at room temperature and retains the state of the liquid. The ionic liquid may be referred to as an ionic liquid, a low melting point molten salt, or a room temperature molten salt. From the viewpoint of stability in the atmosphere and heat resistance in the secondary battery, it is desirable that the non-aqueous solvent has low volatility, specifically, a vapor pressure at a room temperature of 150 Pa or less, but the non-aqueous solvent is not limited thereto. By using a low-volatile solvent such as an ionic liquid or an ether-based solvent that exhibits similar properties to those of the ionic liquid for the non-aqueous electrolyte solution, the volatilization of the non-aqueous electrolyte solution from the semi-solid electrolyte layer can be suppressed.

The content of the non-aqueous electrolyte solution in the semi-solid electrolyte layer is not particularly limited, but it is desirably 40 to 90% by volume. When the content of the non-aqueous electrolyte solution is small, interface resistance between the electrode and the semi-solid electrolyte layer may increase. When the content of the non-aqueous electrolyte solution is large, the non-aqueous electrolyte solution may leak out from the semi-solid electrolyte layer. When the semi-solid electrolyte layer is formed in a sheet shape, the content of the non-aqueous electrolyte solution in the semi-solid electrolyte layer is desirably 50 to 80% by volume, and more desirably 60 to 80% by volume. When a semi-solid electrolyte layer is formed by coating a mixture of a semi-solid electrolyte and a solution in which a semi-solid electrolyte binder is dissolved in a dispersion solvent on an electrode, the content of a non-aqueous electrolyte solution in the semi-solid electrolyte layer is desirably 40% to 60% by volume.

The weight ratio of the main solvent in the non-aqueous electrolyte solution is not particularly limited, but the weight ratio of the main solvent in the total amount of the solvent in the non-aqueous electrolyte solution is desirably 30 to 70% by weight, more desirably 40 to 60% by weight, and particularly desirably 45 to 55% by weight from the viewpoint of battery stability and high-speed charge/discharge.

### Organic Solvent

Examples of the organic solvent include carbonic acid esters such as ethylene carbonate (EC), butylene carbonate (BC), propylene carbonate (PC), dimethyl carbonate (DMC), diethyl carbonate (DEC), and ethyl methyl carbonate (EMC), γ-butyrolactone (GBL), formamide, dimethylformamide, trimethyl phosphate (TMP), triethyl phosphate (TEP), tris(2,2,2-trifluoroethyl)phosphite (TFP), and dimethyl methylphosphonate (DMMP). These non-aqueous solvents may be used alone or in combination of two or more.

### Electrolyte Salt

When the non-aqueous solvent contains an organic solvent, the non-aqueous electrolyte solution contains an electrolyte salt. It is desirable that the electrolyte salt can be homogeneously dispersed in the main solvent. A lithium salt containing lithium as a cation and the above anion may be used, and examples thereof include, but are not limited to, lithium bis(fluorosulfonyl)imide (LiFSI), lithium bis(trifluoromethanesulfonyl)imide (LiTFSI), lithium bis(pentafluoroethanesulfonyl)imide (LiBETI), lithium tetrafluoroborate (LiBF₄), lithium hexafluorophosphate (LiPF₆), and lithium triflate. These materials may be used alone or in combination of two or more.

### Ether-Based Solvent

The ether-based solvent constitutes a solvated electrolyte salt and a solvated ionic liquid. As the ether-based solvent, a known glyme (generic name for symmetric glycol diether represented by R—O(CH₂CH₂O)n-R′ (R and R′ are saturated hydrocarbons, and n is an integer) exhibiting properties similar to those of an ionic liquid can be utilized. From the viewpoint of ion conductivity, tetraglyme (tetraethylene dimethyl glycol, G4) and triglyme (triethylene glycol dimethyl ether, G3) can be preferably used. The volatilization temperature of a complex of an ether-based solvent such as G5 having n of 5 or more and the solvated electrolyte salt is 246° C. or higher. As the ether-based solvent, a crown ether (generic name of macrocyclic ether represented by (—CH₂—CH₂—O)ₙ (n is an integer)) can be utilized. Specifically, 12-crown-4, 15-crown-5, 18-crown-6, and dibenzo-18-crown-6, and the like can be preferably used, but the ether-based solvent is not limited thereto. These ether-based solvents may be used alone or in combination of two or more. It is preferable to use tetraglyme and triglyme from the viewpoint that a complex structure with the solvated electrolyte salt can be used.

Examples of the solvated electrolyte salt that can be utilized include, but are not limited to, lithium salts such as LiFSI, LiTFSI, LiBETI, LiBF₄, and LiPF₆. As the non-aqueous solvent, mixtures of ether-based solvents and solvated electrolyte salts may be used alone or in combination of two or more.

### Negative Electrode Interface Stabilizer

The non-aqueous electrolyte solution may contain a negative electrode interface stabilizer. The non-aqueous electrolyte solution contains the negative electrode interface stabilizer, whereby the rate characteristics of the secondary battery and the battery life can be improved. The amount of the negative electrode interface stabilizer added is preferably 30% by volume or less, and particularly preferably 10% by volume or less, based on the weight of the non-aqueous electrolyte solution. When the amount of the negative electrode interface stabilizer added is 30% by weight or more, ionic conductivity may be hindered or the reaction of the negative electrode interface stabilizer with the electrode may cause increased resistance. Examples of the negative electrode interface stabilizer include, but are not limited to, vinylene carbonate (VC) and fluoroethylene carbonate (FEC). These negative electrode interface stabilizers may be used alone or in combination of two or more.

### Semi-Solid Electrolyte Binder

As the semi-solid electrolyte binder (insulation layer binder), a fluorine-based resin is suitably used. Examples of the fluorine-based resin include, but are not limited to, PTFE, PVDF, and P(VdF-HFP). These semi-solid electrolyte binders may be used alone or in combination of two or more. By using PVDF or P(VdF-HFP), adhesion between the insulation layer 300 and the electrode current collector is improved, thereby improving battery performance.

### Semi-Solid Electrolyte

The semi-solid electrolyte is constituted by carrying or retaining the non-aqueous electrolyte solution on the carrier particles. In a method for preparing the semi-solid electrolyte, the non-aqueous electrolyte solution and the carrier particles are mixed at a specific volume ratio, and an organic solvent such as methanol is added and mixed to prepare a semi-solid electrolyte slurry. Thereafter, the slurry is spread in a petri dish and the organic solvent is distilled off to obtain a semi-solid electrolyte powder.

### EXAMPLES

Hereinafter, the present invention will be more specifically described by way of Examples, but the present invention is not limited to these Examples.

### Example 1

### Preparation of Semi-Solid Electrolyte

G4 and LiTFSI were weighed at a molar ratio of 1:1, put in a beaker, and mixed to a homogeneous solvent to prepare a lithium glyme complex. The lithium glyme complex and fumed silica nanoparticles having a particle diameter of 7 nm as carrier particles were weighed at a volume ratio of 80:20. Furthermore, methanol was weighed so that the volume of methanol was twice as much as that of the lithium glyme complex, put into a beaker together with a stirring bar, and stirred at 600 rpm using a stirrer to obtain a homogeneous mixture. This mixture was put into an eggplant-shaped flask, and dried at 100 mbar and 60° C. for 3 hours using an evaporator. After drying, the powder was passed through a sieve of 100 μm mesh to obtain a powdered semi-solid electrolyte.

### Preparation of Semi-Solid Electrolyte Layer

The powdered semi-solid electrolyte and PTFE were weighed at a weight ratio of 95:5, and put into a mortar, followed by homogeneously mixing. This mixture was set in a hydraulic pressing machine with a PTFE sheet interposed therebetween, and pressed at 400 kgf/cm². Furthermore, the pressed mixture was rolled with a roll pressing machine with a gap set to 500, to prepare a sheet-like insulation layer 300 (semi-solid electrolyte layer) having a thickness of 200 μm. The sheet-like insulation layer 300 was punched to a diameter of 5 mm. The semi-solid electrolyte layer was impregnated in a container containing DMC. The semi-solid electrolyte layer was then taken out from the container, and dried. The lithium glyme complex contained in the semi-solid electrolyte layer was removed by repeating the impregnation of the semi-solid electrolyte layer into the container and the drying of the semi-solid electrolyte layer.

### Thermal Analysis

The semi-solid electrolyte layer from which the lithium glyme complex was removed was transferred to an aluminum pan having a diameter of 5.2 mm. Into the aluminum pan, a non-aqueous electrolyte solution containing LiPF₆ dissolved at a concentration of 1 mol/L was injected into a mixed solvent of ethylene carbonate (EC) and ethyl methyl carbonate (EMC) at a weight ratio of 1:2. A thermogravimetric-differential thermal analyzer (TG-DTA) was used to measure the weight change rate of the semi-solid electrolyte layer at a temperature rising rate of 5° C./min. A measurement temperature range was set to be from room temperature (25° C.) to 350° C. Specifically, the weight of the semi-solid electrolyte layer at room temperature immediately before the start of measurement was defined as 100%, and the weight of the semi-solid electrolyte layer at 350° C. was defined as 0%.

The weight change rate of the semi-solid electrolyte layer at room temperature to 350° C. was measured.

In the above measurement, a weight change amount purely derived from the volatilization of the electrolytic solution was measured. A temperature at which the weight of the semi-solid electrolyte layer was reduced by 10%, that is, a temperature at which the weight of the semi-solid electrolyte layer reached 90% of the weight of the semi-solid electrolyte layer at room temperature immediately before the start of measurement was measured as a volatilization temperature. A difference between the volatilization temperature and a temperature at which the weight was reduced by 10% compared to the weight of only the electrolyte solution at room temperature immediately before the start of measurement was measured as a volatilization difference temperature, and the influence of the fine structure in the insulation layer 300 or the battery cell sheet on the volatilization temperature was considered.

### Example 2

Thermal analysis was performed in the same manner as in Example 1 except that the weight change rate of the total weight of an insulation layer 300, an electrode mixture layer, and an electrode current collector was measured in place of the weight change rate of a semi-solid electrolyte layer in a battery cell sheet prepared below.

### Preparation of Positive Electrode 100

LiNi_{0.33}Mn_{0.33}Co_{0.33}O₂ as a positive electrode active material, acetylene black as a positive electrode conductive material, and P(VdF-HFP) as a positive electrode binder were weighed at a weight ratio of 84:7:9, and mixed with an N-methylpyrrolidone solvent to obtain a positive electrode slurry. The positive electrode slurry was coated on an aluminum foil that was a positive electrode current collector 120, and dried at 120° C. to remove N-methylpyrrolidone, followed by roll-pressing. At this time, a positive electrode 100 having a double-sided coating amount of 37.5 g/cm² and a density of 2.6 g/cm³ was obtained.

### Preparation of Coated Separator

Silica particles were used as separator particles, and P(VdF-HFP) was used as a separator binder. The slurry obtained by mixing the separator particles with the separator binder at a weight ratio of 89.3:10.7 was coated on the positive electrode 100 while the viscosity of the slurry was adjusted with an N-methyl-2-pyrrolidone dispersion solution, to form an insulation layer 300 (coated separator) having a thickness of 20 μm on the positive electrode 100, thereby obtaining a battery cell sheet. The insulation layer 300 was formed, and the battery cell sheet was then dried at 100° C. The same non-aqueous electrolyte solution as that in Example 1 was injected into the dried battery cell sheet.

### Example 3

A battery cell sheet was prepared, and subjected to thermal analysis in the same manner as in Example 2 except for the following.

### Preparation of Negative Electrode 200

Graphite as a negative electrode active material, the same material as the positive electrode conductive material in Example 2 as a negative electrode conductive material, and the same material as the positive electrode binder in Example 2 as a negative electrode binder were weighed at a weight ratio of 88:2:10, and mixed with an N-methylpyrrolidone solvent to obtain a negative electrode slurry. The negative electrode slurry was coated on a copper foil that was a negative electrode current collector 220, and dried at 120° C. to remove N-methylpyrrolidone, followed by uniaxially pressing. At this time, a negative electrode 200 having a double-sided coating amount of 18 g/cm² and a density of 1.6 g/cm³ was obtained.

### Examples 4 and 5

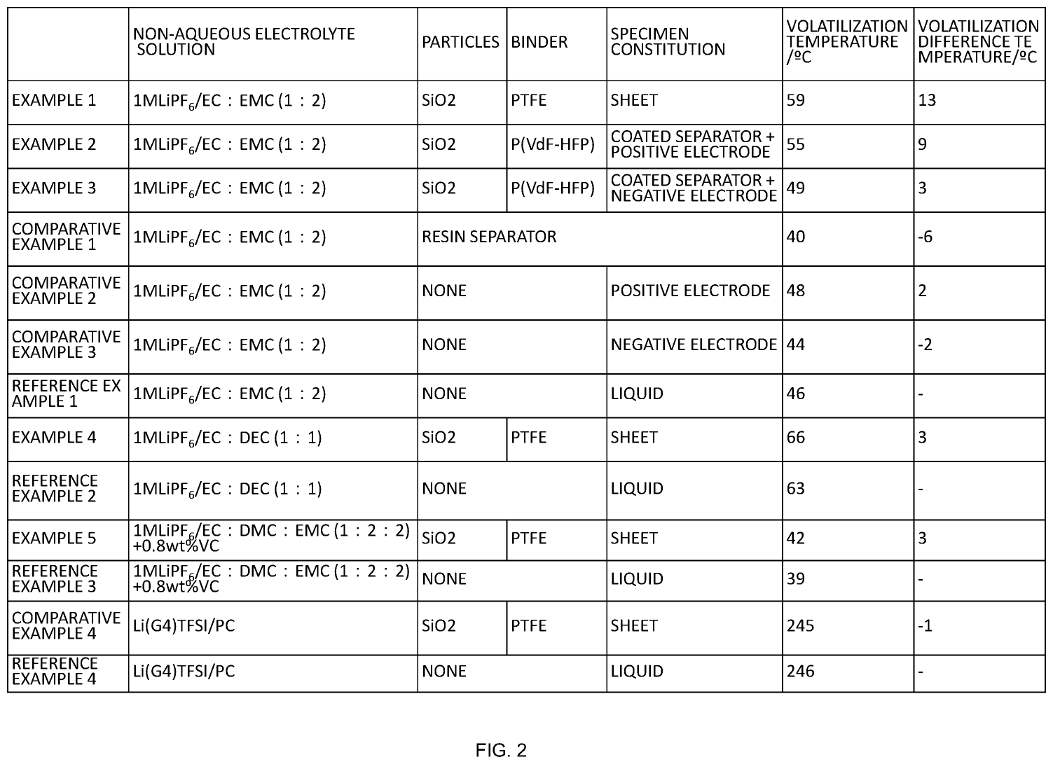

Examples 4 and 5 were performed in the same manner as in Example 1 except that a non-aqueous electrolyte solution was changed as shown in FIG. 2.

### Comparative Example 1

Comparative Example 1 was performed in the same as Example 1 except that a resin separator having a three-layered structure of polypropylene/polyethylene/polypropylene and having a thickness of 30 μm was used for an insulation layer 300.

### Comparative Examples 2 and 3

Comparative Examples 2 and 3 were performed in the same manner as in Example 2 and Example 3 except that an insulation layer 300 was not coated on an electrode.

### Comparative Example 4

Comparative Example 4 was performed in the same manner as in Example 1 except that a non-aqueous electrolyte solution was changed as shown in FIG. 2.

### Reference Examples 1 to 4

The non-aqueous electrolyte solution used alone in each of Examples 1 to 5 and Comparative Examples 1 to 4 was subjected to thermal analysis in the same manner as in Example 1. In Reference Examples 1 to 4, the volatilization temperature is measured in a state where no insulation layer 300 or electrode is present, so that no volatilization difference temperature is present. Therefore, the volatilization differential temperature in Reference Examples 1 to 4 had no results.

### Results and Discussion

FIG. 2 shows conditions and results of Examples, Comparative Examples, and Reference Examples. EMC having a high vapor pressure was contained in Reference Example 1, so that the weight of the non-aqueous electrolyte solution was reduced with increase in temperature, and the volatilization temperature reached 46° C. Meanwhile, in Comparative Example 1, the volatilization temperature was 40° C., which was reduced by 6° C. compared to that in Reference Example 1, so that the volatilization rate of the volatile solvent such as EMC contained in the non-aqueous electrolyte solution was increased. This is considered to be because the resin separator has an internal porous structure having a large specific surface area, so that the volatilization rate of the non-aqueous electrolyte solution is increased, which causes a decreased volatilization temperature.

Meanwhile, the volatilization temperature in Example 1 was 59° C., which was higher by 13° C. than that in Reference Example 1. It is considered that, when the volatilization rate is simply determined by the internal specific surface area of the semi-solid electrolyte layer, the internal specific surface area of the semi-solid electrolyte layer containing oxide particles is increased as with the resin separator, so that the volatilization rate of the non-aqueous electrolyte solution is increased, which causes a decreased volatilization temperature. Meanwhile, in the semi-solid electrolyte layer, it is considered that the increase in the volatilization temperature due to the interaction between the surface of the carrier particles and the non-aqueous electrolyte solution is larger than the decrease in the volatilization temperature due to the increase in the internal specific surface area of the semi-solid electrolyte layer, so that the volatilization temperature is higher than that in Reference Example 1. Also in Examples 4 and 5 in which the components of the non-aqueous electrolyte solution were changed in Example 1, the same tendency as that in Example 1, that is, the volatilization temperature when the non-aqueous electrolyte solution was contained in the semi-solid electrolyte layer was higher than that in Reference Examples 2 and 3.

In Example 2, the volatilization temperature was 55° C., which was higher by 9° C. than that in Reference Example 1. The volatilization temperature of Example 2 was higher than the volatilization temperature (48° C.) of Comparative Example 2 in which the insulation layer 300 was not formed. It is considered that the volatilization difference temperature of Comparative Example 2 was only 2° C., so that, by coating the insulation layer 300, the silica oxide particles functioning as the carrier particles of the non-aqueous electrolyte solution contained in the insulation layer 300, and the interaction between the P(VdF-HFP) binder and the non-aqueous electrolyte solution cause an increased volatilization temperature. The same tendency as that in Example 2 and Comparative Example 2 was observed also in Example 3 and Comparative Example 3 in which the substrate containing the coated insulation layer 300 was changed to the negative electrode 200 in Example 2 and Comparative Example 2.

As in Examples 2 and 3, it was found that, when the thickness of the insulation layer 300 coated on the positive electrode 100 or the negative electrode 200 is 20 μm or more, the volatilization of the non-aqueous electrolyte solution can be suppressed. It was found that, when the thickness of the insulation layer 300 is 200 μm as in Example 1, the volatilization temperature is higher than that in Examples 2 and 3, so that the thicker insulation layer 300 can suppress the volatilization of the non-aqueous electrolyte solution. Meanwhile, as the thickness of the insulation layer 300 is increased, the internal resistance of the secondary battery 1000 may be increased. Therefore, it was found that the thickness of the insulation layer 300 is desirably 20 to 200 μm in order to suppress the volatilization of the non-aqueous electrolyte solution to reduce the internal resistance of the secondary battery 1000.

The volatilization temperature was 246° C. in Reference Example 4 having a lithium glyme complex that was a low-volatile solvent. In Comparative Example containing the insulation layer 300, the volatilization temperature was reduced by 1° C. compared to Reference Example 4. When the volatilization temperature of the non-aqueous electrolyte solution is increased to 246° C., the interaction between the non-aqueous electrolyte solution and the carrier particles is less likely to occur, which makes it difficult to increase the volatilization temperature even when the secondary battery 1000 includes the insulation layer 300. Therefore, it was found that the volatilization temperature of the non-aqueous electrolyte solution is set lower than 246° C., whereby the volatilization of the non-aqueous electrolyte solution by the insulation layer 300 can be effectively suppressed. It was found that, as the volatilization temperature of the non-aqueous electrolyte solution is lower, the volatilization suppression effect of the non-aqueous electrolyte solution is more remarkable.

### REFERENCE SIGNS LIST

100 positive electrode
110 positive electrode mixture layer
120 positive electrode current collector
130 positive electrode tab part
200 negative electrode
210 negative electrode mixture layer
220 negative electrode current collector
230 negative electrode tab part
300 insulation layer
400 electrode body
500 outer casing
1000 secondary battery

1. An insulation layer comprising:
a non-aqueous electrolyte solution;
insulation layer particles; and
an insulation layer binder,
wherein the non-aqueous electrolyte solution contains a non-aqueous solvent having a volatilization temperature of lower than 246° C., and
when the insulation layer is heated from a reference temperature, a temperature at which a weight of the insulation layer is reduced by 10% compared to the weight of the insulation layer at the reference temperature is higher by at least 3° C. than a temperature at which a weight of the non-aqueous solvent is reduced by 10% compared to the weight of the non-aqueous solvent at the reference temperature.

2. The insulation layer according to claim 1, wherein the insulation layer has a thickness of 20 to 200 μm.

3. The insulation layer according to claim 1, wherein, when the insulation layer is heated from the reference temperature, the temperature at which the weight of the insulation layer is reduced by 10% compared to the weight of the insulation layer at the reference temperature is higher by at least 5° C. than the temperature at which the weight of the non-aqueous solvent is reduced by 10% compared to the weight of the non-aqueous solvent at the reference temperature.

4. A battery cell sheet comprising:
the insulation layer according to claim 1; and
an electrode.

5. A battery comprising:
the insulation layer of claim 1;
a positive electrode; and
a negative electrode.

6. The insulation layer according to claim 1, wherein primary particles of the insulation layer particles is 1 to 50 nm.

7. The insulation layer according to claim 1, wherein the insulation layer particles contain any one of SiO₂ particles, Al₂O₃ particles, ceria (CeO₂) particles, and ZrO₂ particles.
